(19) United States
(12) Patent Application Publication
(10) Pub. No.: US 2024/0231414 A1
(43) Pub. Date: Jul. 11, 2024

(54) OPERATED DEVICE AND DEVICE FOR OPERATING

(71) Applicant: OMRON Corporation, KYOTO (JP)

(72) Inventor: Satoshi TAKAMORI, Kyoto-shi, KYOTO (JP)

(73) Assignee: OMRON Corporation, KYOTO (JP)

(21) Appl. No.: 18/559,558

(22) PCT Filed: Mar. 17, 2022
(86) PCT No.: PCT/JP2022/012136

§ 371 Date: Nov. 7, 2023

(30) Foreign Application Priority Data
Jun. 24, 2021 (JP) 2021-104691

(51) Int. Cl. G05G 9/047; G06F 3/0338

(52) U.S. Cl. CPC G05G 9/047; G06F 3/0338

(57) ABSTRACT

Disclosed are: an operated device 2 comprising a spherical body 21 that moves upon receiving an operation from an external source, and a holding member 22 for movably holding the spherical body 21 from the outside; and a device for operating that comprises the operated device 2. The holding member 22 provided to the operated device 2 and the device for operating has a sliding member 23 for contacting an outer surface of the spherical body 21 and is provided with a pressing member 26 that presses the spherical body 21 and brings the spherical body 21 into contact with the sliding member 23, the spherical body 21 moving while being in contact with the sliding member 23.

### TECHNICAL FIELD

The present invention relates to an operated device including a spherical body that moves upon receiving an operation from an external source, and a device for operating that includes such an operated device.

### RELATED ART

An operated device called a joystick has become popular as an operated device that is moved to operate various devices such as computer games, various toys and industrial robots. In an operated device in the form called a joystick, by tilting the stick in various directions, an operation target moves in the tilting direction, thereby enabling intuitive operation. As such an operated device, for example, Patent Literature 1 proposes a variable resistance pointing device that detects inclination by variable resistances disposed on each of an X axis and a Y axis.

### CITATION LIST

### Patent Literature

[Patent Literature 1] Taiwan Utility Model Patent No. 371503

### SUMMARY OF INVENTION

### Technical Problem

As an example of a joystick as exemplified in Patent Literature 1, an operated device that includes a spherical body that moves upon receiving an operation, detects movement of the spherical body and outputs an operation signal is being considered. An operated device using such a spherical body may have a problem that friction between the spherical body and a holding member that holds the spherical body reduces operability.

The present invention has been made in view of such circumstances, and a main object of the present invention is to provide an operated device that may prevent a decrease in operability by disposing a sliding section on a holding member.

Another object of the present invention is to provide a device for operating that includes such an operated device.

### Solution to Problem

In order to solve the above issues, an operated device disclosed in the present application includes a spherical body that moves upon receiving an operation from an external source, and a holding member that movably holds the spherical body from the outside. The holding member has a sliding section that contacts an outer surface of the spherical body, and the operated device includes a pressing member that presses the spherical body and brings the spherical body into contact with the sliding section. The spherical body moves while being in contact with the sliding section.

Further, in the operated device, the pressing member presses the spherical body from a first hemispherical surface side, and the sliding section is disposed to come into contact merely with a second hemispherical surface side opposite to the first hemispherical surface side.

Further, in the operated device, an inner surface of the holding member is formed in a concave spherical shape along the outer surface of the spherical body, the inner surface of the holding member has a radius of a second concave spherical surface side facing the second hemispherical surface side opposite to the first hemispherical surface side of the spherical body shorter than a radius of a first concave spherical surface side facing the first hemispherical surface side of the spherical body that receives pressure from the pressing member.

Further, in the operated device, the sliding section is formed of a spherical band-shaped member cut along two planes perpendicular to a pressing direction of the pressing member.

Further, in the operated device, the sliding section is formed by using a material having a smaller coefficient of friction than other parts of the holding member.

Further, in the operated device, the sliding section is formed by using polyacetal resin (POM), polyamide resin (PA), or polytetrafluoroethylene resin (PTFE).

Further, in the operated device, the movement of the spherical body is tilting movement in which a central axis parallel to the pressing direction of the pressing member is tilted, the sliding section is disposed such that an elevation angle from a center of the spherical body is a first angle with respect to a plane perpendicular to the pressing direction of the pressing member, the central axis is tiltable to a second angle with respect to a plane perpendicular to the pressing direction of the pressing member by tilting movement, and the first angle is ½ or less of the second angle.

Further, in the operated device, the sliding section is formed as a rolling bearing.

Furthermore, a device for operating described in the present application includes the operated device and an output section that outputs an operation signal based on movement of the spherical body included in the operated device to the external source.

The operated device and the device for operating disclosed in the present application slide on the spherical body at the sliding section of the holding member.

### Effects of Invention

In the operated device and the device for operating according to the present invention, the holding member that movably holds the spherical body includes a sliding section that comes into contact with the outer surface of the spherical body, and the spherical body moves by sliding while being in contact with the sliding section. Further, by suppressing the frictional resistance of the sliding section, excellent effects such as reducing the friction between the spherical body and the sliding section and preventing a decrease in operability are achieved.

### BRIEF DESCRIPTION OF DRAWINGS

FIG. 1 is a schematic perspective view showing an example of the appearance of a device for operating incorporating an operated device disclosed in the present application.

FIG. 2 is a schematic perspective view showing an example of the appearance of a device for operating according to the present application.

FIG. 3 is a schematic perspective view showing an example of an operated device disclosed in the present application.

FIG. 4 is a schematic exploded perspective view showing an example of an operated device disclosed in the present application.

FIG. 5 is a schematic cross-sectional view showing an example of an operated device disclosed in the present application.

FIG. 6 is a schematic perspective view showing an example of a sliding member included in an operated device disclosed in the present application.

FIG. 7 is a schematic cross-sectional view showing an example of an operated device disclosed in the present application.

FIG. 8 is a schematic cross-sectional view showing an example of an operated device disclosed in the present application.

FIG. 9 is a schematic perspective view showing an example of an operated device disclosed in the present application.

FIG. 10 is a schematic cross-sectional view showing an example of an operated device disclosed in the present application.

FIG. 11 is a schematic perspective view showing an example of a sliding member included in an operated device disclosed in the present application.

FIG. 12 is a schematic cross-sectional view showing an example of an operated device disclosed in the present application.

FIG. 13 is a schematic perspective view showing an example of a sliding member included in an operated device disclosed in the present application.

FIG. 14 is a schematic cross-sectional view showing an example of an operated device disclosed in the present application.

FIG. 15 is a schematic cross-sectional view showing an example of an operated device disclosed in the present application.

FIG. 16 is a schematic perspective view showing an example of a holding member included in an operated device disclosed in the present application.

FIG. 17 is a schematic cross-sectional view showing an example of an operated device disclosed in the present application.

FIG. 18 is a schematic perspective view showing an example of a holding member included in an operated device disclosed in the present application.

FIG. 19 is a schematic cross-sectional view showing an example of an operated device disclosed in the present application.

FIG. 20 is a schematic perspective view showing an example of a sliding member included in an operated device disclosed in the present application.

FIG. 21 is a schematic cross-sectional view showing an example of an operated device disclosed in the present application.

FIG. 22 is a schematic perspective view showing an example of a sliding member included in an operated device disclosed in the present application.

FIG. 23 is a schematic cross-sectional view showing an example of an operated device disclosed in the present application.

FIG. 24 is a schematic cross-sectional view showing an example of an operated device disclosed in the present application.

FIG. 25 is a schematic perspective view showing an example of a sliding member included in an operated device disclosed in the present application.

FIG. 26 is a schematic cross-sectional view showing an example of an operated device disclosed in the present application.

FIG. 27 is a schematic perspective view showing an example of an operated device disclosed in the present application.

FIG. 28 is a schematic exploded perspective view showing an example of an operated device disclosed in the present application.

FIG. 29 is a schematic cross-sectional perspective view showing an example of an operated device disclosed in the present application.

FIG. 30 is a block diagram showing a functional configuration example of a device for operating disclosed in the present application.

### DESCRIPTION OF EMBODIMENTS

Hereinafter, embodiments will be described with reference to the drawings. An operated device described in the present application is a device that moves upon receiving an operation from an operator. The operated device is incorporated into a device for operating such as a joystick type controller that outputs an operation signal which operates an operation target. For example, by using the device for operating described in the present application as a joystick type controller, the device for operating may be used to operate various operation targets such as computer games, others, various toys, various moving objects, various measuring devices, and industrial robots. Hereinafter, a device for operating 1 applied to a joystick type controller and an operated device 2 incorporated as an operating mechanism in the device for operating 1 will be described with reference to the drawings.

### <Device for Operating>

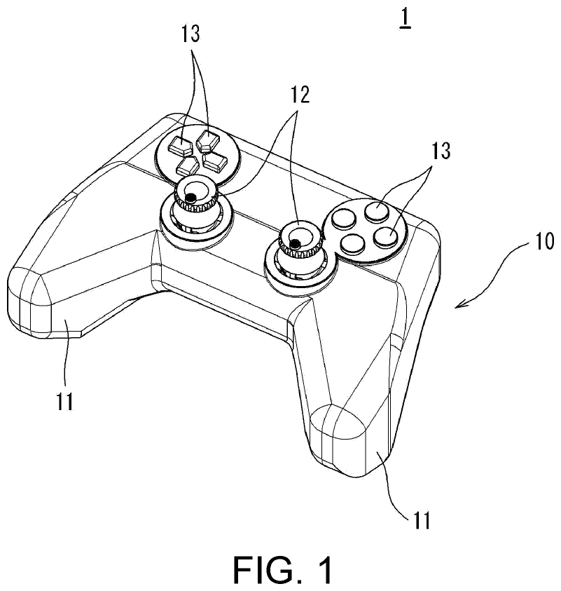

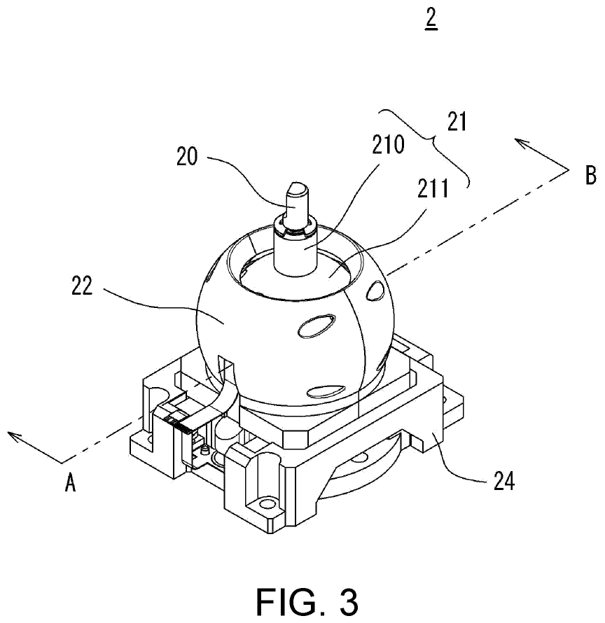

FIG. 1 is a schematic perspective view showing an example of the appearance of a device for operating 1 incorporating an operated device 2 disclosed in the present application. The device for operating 1 includes a casing 10, and the casing 10 has grip sections 11 formed at both ends thereof to be gripped with the right hand and the left hand, respectively. When the grip sections 11 at both ends are gripped, the positions on the upper surface where the fingers touch are opened in a substantially circular shape, operation sections 12 for operating an operation target protrude from the casing 10 through openings. The operation section 12 is attached to a shaft member 20 (see FIG. 3 and the like), which will be described later, included in the operated device 2 incorporated in the device for operating 1. Further, on the upper surface side, multiple operation buttons 13 are disposed at positions that may be pressed by fingers of the operator. In the device for operating 1 illustrated in FIG. 1, two operated devices 2, one for detecting movement based on an operation of the right hand and the other for detecting movement based on an operation of the left hand, are incorporated into one casing 10. In the present application, for convenience of description, a side that is located above when the operator operates in a general posture, that is, the side on which the operation buttons 13 are disposed and the operation sections 12 protrude will be described as the upper side.

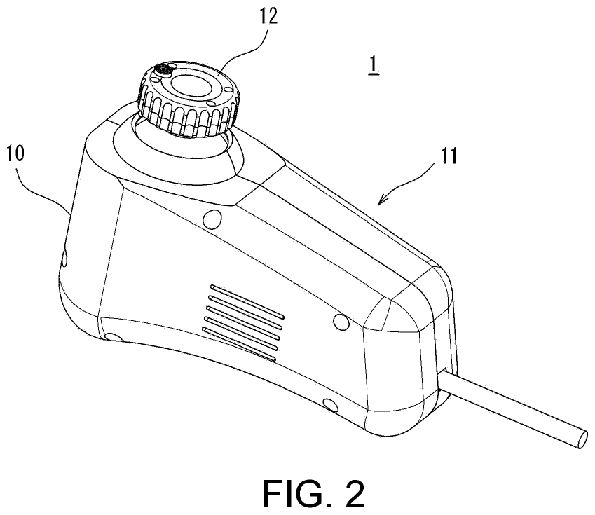

FIG. 2 is a schematic perspective view showing an example of the appearance of the device for operating 1 disclosed in the present application. FIG. 2 shows another form of the device for operating 1. The device for operating 1 illustrated in FIG. 2 incorporates various mechanisms such as one operated device 2 in one casing 10, and is formed as a controller for one-handed operation. For example, when applied to an industrial robot controller, such a form is particularly effective because it is conceivable to operate the device for operating 1 according to the present invention with one hand and perform other tasks with the other hand. Such a form is also effective as a game controller in which different devices for operating 1 are held with the left hand and the right hand.

### <Operated Device>

Next, the operated device 2 will be described. The operated device 2 may be realized in various forms. Hereinafter, various forms of the operated device 2 will be described.

### First Embodiment

### <Structure>

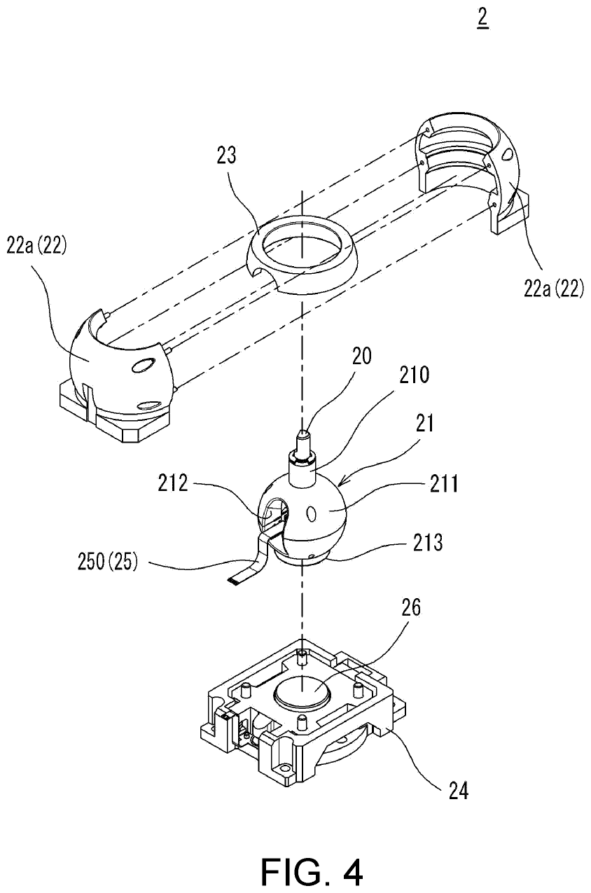

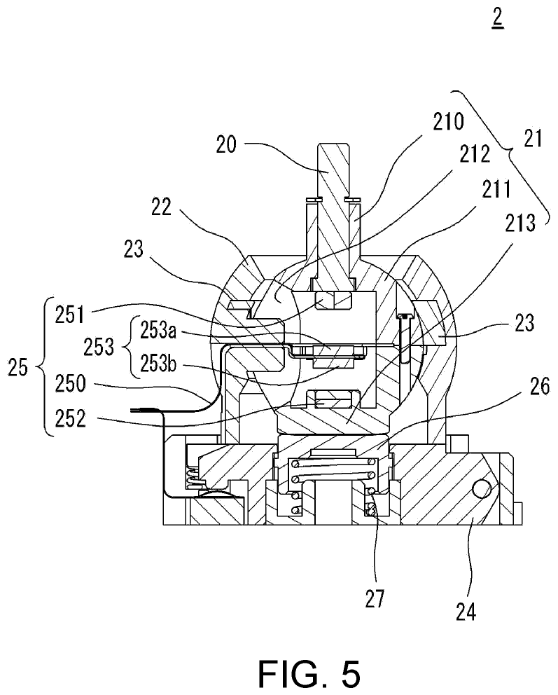

FIG. 3 is a schematic perspective view showing an example of the operated device 2 disclosed in the present application. FIG. 4 is a schematic exploded perspective view showing an example of the operated device 2 disclosed in the present application. FIG. 5 is a schematic cross-sectional view showing an example of the operated device 2 disclosed in the present application. FIGS. 3 to 5 illustrate the operated device 2 incorporated into the device for operating 1 disclosed in the present application. FIG. 5 shows a schematic cross-sectional view of the internal structure of the operated device 2 cut along a vertical plane taken along a line A-B shown in FIG. 3. The operated device 2 includes various members such as the shaft member 20, a spherical body 21, a holding member 22, a sliding member 23 (sliding section), a lower mechanism 24, a detection unit 25, and the like. The lower mechanism 24 incorporates various members such as a pressing member 26 and an urging member 27. In the following description, as shown in FIGS. 3 to 5, a state in which an imaginary central axis parallel to a longitudinal direction of the shaft member 20 and passing through a center of the spherical body 21 is oriented vertically is defined as a reference posture.

The shaft member 20 has a long rod shape, and the operation section 12 is attached to the upper end. A lower part of the shaft member 20 is inserted into an insertion section 210 which is in a substantially circular cylindrical shape formed in the spherical body 21 and is formed to protrude from the upper end of the spherical body 21. The upper part of the shaft member 20 is processed into a shape to which the operation section 12 may be attached. An edge section of the lower end of the shaft member 20 protrudes in a radial direction in the form of a flange and is located near the inner surface of the spherical body 21. The protrusion of the edge section of the lower end of the shaft member 20 loosely fits into a concave section in a cylindrical shape formed on the top surface of the spherical body 21 with some play. Near the center of the shaft member 20, a metal stopper such as a C-ring or an E-ring that is substantially U-shaped is fitted. The shaft member 20 has a protrusion in the form of a flange at the lower end that loosely fits into a concave section in the spherical body 21 to restrict movement upward, a stopper near the center contacts the upper end of the insertion section 210 of the spherical body 21 to restrict movement downward.

The spherical body 21 is a hollow member in a substantially spherical shape, and is formed in a shape in which the insertion section 210 in a substantially cylindrical shape through which the shaft member 20 is inserted is attached to a spherical body section 211 in a substantially spherical shape. An opening section 212 through which a connection line 250 of the detection unit 25 is passed is formed in the side surface of the spherical body section 211, and the connection line 250 extends outside through the opening section 212. The opening section 212 has an oval shape extending in a longitudinal direction. A pressed section 213 in a substantial disk shape is formed at the lower end of the spherical body 21.

The spherical body 21 receives an operation from an external source (operator) via the operation section 12 and the shaft member 20, and moves in response to the operation. The movement of the spherical body 21 in response to the operator's operation is movement with respect to an imaginary central axis that is parallel to the longitudinal direction of the shaft member 20 and passes through the center of the spherical body 21. Specifically, the movement of the shaft member 20 is movement in which the central axis is tilted around the center of the spherical body 21 as a fulcrum, movement of rotating in a circumferential direction around the central axis and movement of moving in an up-and-down direction (extending direction of the central axis). When the shaft member 20 performs tilting movement, the spherical body 21 performs tilting movement with the center as a fulcrum in conjunction with the movement of the shaft member 20. When the shaft member 20 moves up and down, the spherical body 21 moves up and down in conjunction with the movement of the shaft member 20. The spherical body 21 does not move in conjunction with the rotation of the shaft member 20.

The holding member 22 is a member disposed to cover the spherical body 21, and has a substantially spherical outer shape. The inner surface of the holding member 22 is formed in a substantially concave spherical shape along the outer surface of the spherical body 21, and movably holds the spherical body 21 from the outside. The holding member 22 is assembled by joining two half bodies 22a separable in a lateral direction.

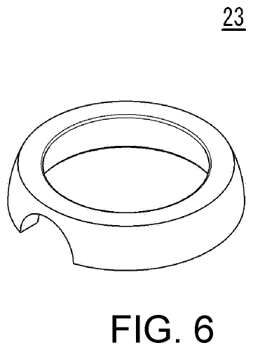

FIG. 6 is a schematic perspective view showing an example of the sliding member 23 included in the operated device 2 disclosed in the present application. The sliding member 23 will be described by using FIGS. 4 to 6. The sliding member 23 is formed into a substantially annular shape in plan view. More specifically, the sliding member 23 has a substantially spherical band shape cut along two horizontal planes, and an arc-shaped notch is formed along the opening section 212 at a position corresponding to the opening section 212 of the spherical body 21. The sliding member 23 is made of a resin having a low coefficient of friction, such as polyacetal resin (POM), polyamide resin (PA), or polytetrafluoroethylene resin (PTFE). The sliding member 23 is fitted into the upper hemispherical surface side of the inner side of the holding member 22 formed in a substantially concave spherical shape, and comes into contact with the spherical body 21 housed within the holding member 22.

In a state of being fitted into the upper hemispherical surface side of the holding member 22 formed in a substantially concave spherical shape, the distance from the center of the inner sphere formed by a concave spherical surface to the inner surface of the holding member 22 disposed on the upper side is shorter than the distance from the center of the inner sphere to the inner surface of the lower hemispherical surface. That is, the radius on the upper hemispherical surface side (second hemispherical surface side) where the sliding member 23 is located is shorter than the radius on the lower hemispherical surface side (first hemispherical surface side). Further, the spherical body 21 is pressed upward from below by the pressing member 26. Therefore, the spherical body 21 pressed from below contacts merely the upper hemispherical surface side of the inner surface of the holding member 22. The spherical body 21 moves while being in contact with the sliding member 23 fitted into the upper hemispherical surface side of the holding member 22. That is, the sliding member 23 is fitted into the holding member 22 as a sliding section that comes into contact with the outer surface of the spherical body 21, and the spherical body 21 moves while being in contact with the sliding member 23 that functions as a sliding section.

Referring to FIGS. 3 to 5 again, the lower mechanism 24 attached to the lower part of the holding member 22 incorporates the pressing member 26 that presses the pressed section 213 at the lower end of the spherical body 21 from below to above. The pressing member 26 has an upper part in a disk shape and a lower part extending downward in a cylindrical shape. The lower mechanism 24 is formed with an annular groove in plan view into which the pressing member 26 is loosely fitted with some play. The lower part of the pressing member 26 is loosely fitted in the groove and moves up and down. Further, the urging member 27 using a return spring such as a compression coil spring is disposed in the groove. The lower end of the urging member 27 is fixed to the inner bottom surface of the groove, and the upper end contacts the pressing member 26 and urges the pressing member 26 upward. When the urging member 27 urges the pressing member 26 upward, the pressing member 26 comes into contact with the pressed section 213 formed at the lower end of the spherical body 21 on the upper surface, and the pressed section 213 is pressed upward. In this way, even when the spherical body 21 performs tilting movement upon receiving an operation, the spherical body 21 moves to return to the reference posture.

In addition to the connection line 250 described above, the detection unit 25 includes members such as a first magnet 251 fixed to the lower end of the shaft member 20, a second magnet 252 fixed to the inner bottom of the spherical body 21, which is the lower end of the spherical body 21, and a magnetic field sensor 253 that detects a magnetic field. The first magnet 251 is disposed near the top inside the spherical body 21. The first magnet 251 is formed of a permanent magnet in a flat and substantially cylindrical shape, and is disposed so that magnetic poles of the first magnet 251 face in a direction perpendicular to the central axis. The second magnet 252 is formed of a permanent magnet in a flat and substantially cylindrical shape, and is disposed so that magnetic poles of the second magnet 252 face in a direction parallel to the central axis. In the present application, the direction of the magnetic poles means the direction connecting the two magnetic poles. Therefore, for example, the disposition of the first magnet 251 in the reference posture may be such that the N pole faces in a horizontal first direction such as the left side, and the S pole may be fixed so as to face a horizontal second direction such as the right side, which is the opposite side to the first direction. Further, for example, the disposition of the second magnet 252 may be fixed such that the N pole faces upward and the S pole faces downward. The magnetic field sensor 253 is configured by using an electronic element such as a Hall IC that detects a magnetic field and outputs an electrical signal based on the detected magnetic field. The magnetic field sensor 253 is formed by combining a first magnetic field sensor 253a that detects a magnetic field formed by the first magnet 251 within the upper hemisphere of the spherical body 21 and a second magnetic field sensor 253b that detects a magnetic field formed by the second magnet 252 within the lower hemisphere of the spherical body 21. In addition, in order to prevent interference between the magnetic field formed by the first magnet 251 and the magnetic field formed by the second magnet 252, in the vicinity of the center inside the spherical body 21, a magnetic shielding plate is disposed to divide the inside of the spherical body 21 into upper and lower parts. The disposed magnetic shield plate allows the first magnetic field sensor 253a to detect the magnetic field formed by the first magnet 251 while suppressing the influence of the magnetic field formed by the second magnet 252. Further, the second magnetic field sensor 253b may detect the magnetic field formed by the second magnet 252 while the influence of the magnetic field formed by the first magnet 251 being suppressed. The magnetic field detected by the magnetic field sensor 253 is output to the external source via the connection line 250 as an electrical signal.

### <Movement>

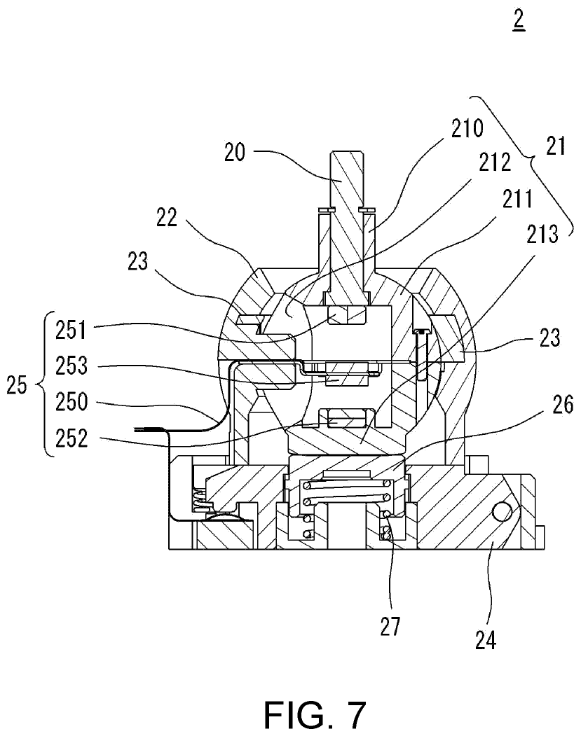

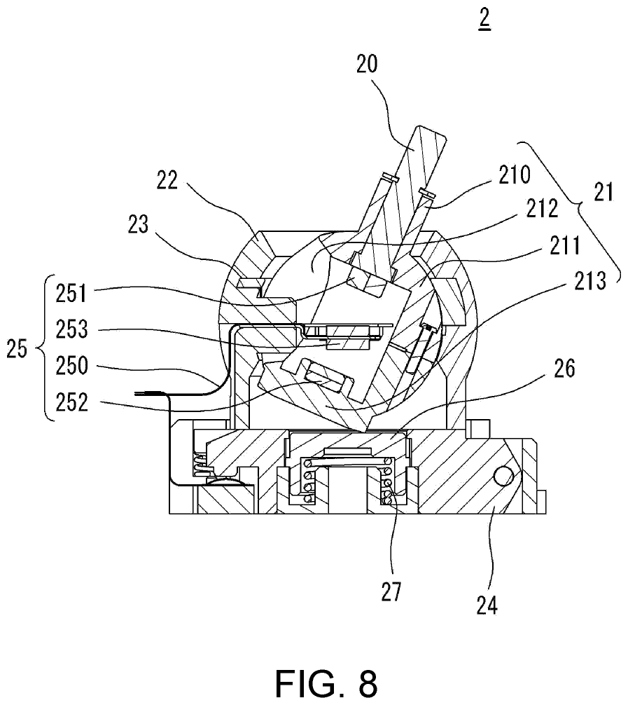

Next, the movement of the operated device 2 disclosed in the present application will be described. FIGS. 7 and 8 are schematic cross-sectional views showing an example of the operated device 2 disclosed in the present application. FIG. 7 shows a state in which the shaft member 20 of the operated device 2 is in the reference posture. The reference posture of the shaft member 20 indicates a state in which the device for operating 1 is not operated by an operator and is positioned in a posture in which the longitudinal direction of the shaft member 20 is in the up-and-down direction. FIG. 8 shows a state in which the shaft member 20 and the spherical body 21 of the operated device 2 are tilted from the reference posture illustrated in FIG. 7 upon receiving the tilting operation by the operator.

When the operation section 12 receives a tilting operation, the shaft member 20 and the spherical body 21 of the operated device 2 tilt with the center of the spherical body 21 as a fulcrum. When the shaft member 20 and the spherical body 21 are in the reference posture as illustrated in FIG. 7, since the pressing member 26 presses the vicinity of the flat center of the pressed section 213 upward, where the center of the spherical body 21 is located, the shaft member 20 and the spherical body 21 have a stable posture. As illustrated in FIG. 8, when the shaft member 20 and the spherical body 21 are tilted, the pressed section 213 presses the pressing member 26 downward at the peripheral edge section. In the state illustrated in FIG. 8, since the pressing member 26 presses the peripheral edge of the pressed section 213 upward, where the center of the spherical body 21 is located, a force acts in a rotational direction in which the spherical body 21 returns to the reference posture. As illustrated in FIG. 8, when the shaft member 20 and the spherical body 21 are tilted from the reference posture, a force acts in the direction of returning to the reference posture, resulting in an unstable state. Therefore, when the tilting force by the operator is released, the shaft member 20 and the spherical body 21 return to the reference postures.

When the shaft member 20 and the spherical body 21 tilt, the magnetic field generated by the first magnet 251 and the magnetic field generated by the second magnet 252 detected by the magnetic field sensor 253 change, the changed state is output to the external source as an electrical signal indicating the tilted state.

When the spherical body 21 of the operated device 2 performs tilting movement from the reference posture upon receiving a tilting operation, further, in any case of performing the movement of returning to the reference posture from the tilted state, the pressing member 26 is in a state of being pressed upward. Therefore, the spherical body 21 moves with the outer surface thereof in contact with the upper hemispherical surface of the inner surface of the holding member 22, which is formed into a substantially concave spherical shape. The sliding member 23 is fitted into the upper hemispherical surface of the holding member 22. The distance from the center of the spherical body 21 to the sliding member 23 is formed to be shorter than the distance from the center of the spherical body 21 to other parts of the holding member 22. Moreover, the spherical body 21 is pressed upward. Therefore, the spherical body 21 performs tilting movement and return movement while maintaining a state in which the spherical body 21 is in contact with the sliding member 23 fitted into the holding member 22. Since the sliding member 23 is formed by using resin having a low coefficient of friction, the frictional resistance between the spherical body 21 and the holding member 22 against the movement of the spherical body 21 may be reduced.

As described above, the operated device 2 disclosed in the present application has excellent effects such as that the sliding member 23 fitted into the upper side of the inner surface of the holding member 22 functions as a sliding section that comes into contact with the spherical body 21 in response to movement such as tilting movement of the spherical body 21, and reduces the frictional resistance between the sliding member 23 and the spherical body 21. In this way, the operator who operates the device for operating 1 may operate the device for operating 1 with little force.

### Second Embodiment

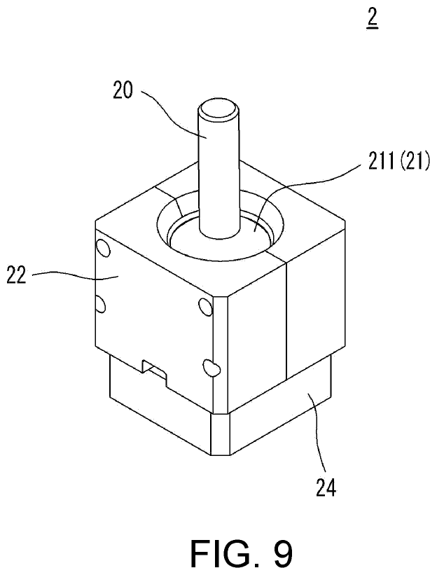

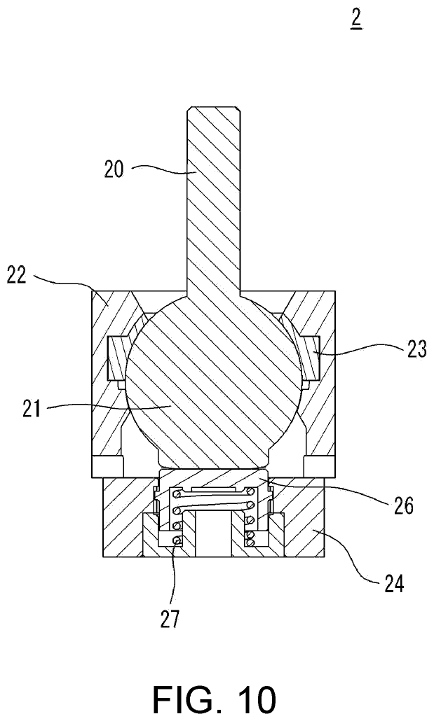

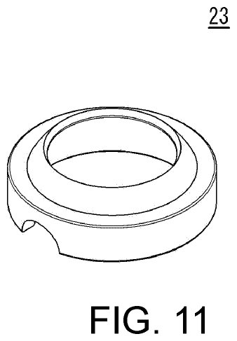

A second embodiment of the operated device 2 is the same as the first embodiment in which the part that the sliding member 23 comes into contact with is enlarged. In the following description, the same reference numerals as in the first embodiment are given to the same configurations as in the first embodiment, and detailed description thereof will be omitted. FIG. 9 is a schematic perspective view showing an example of the operated device 2 disclosed in the present application. FIG. 10 is a schematic cross-sectional view showing an example of the operated device 2 disclosed in the present application. FIG. 11 is a schematic perspective view showing an example of the sliding member 23 included in the operated device 2 disclosed in the present application. In the schematic cross-sectional view illustrated in FIG. 10, in order to make it easier to visually recognize the shapes of the spherical body 21, the holding member 22 and the sliding member 23, the holding member 22 is cut along a cross section where the opening section 212 is not formed, and the insides of the spherical body 21 and the shaft member 20 are omitted and shown with diagonal lines.

The holding member 22 of the operated device 2 according to the second embodiment has a substantially rectangular outer shape and a substantially concave spherical inner surface. The sliding member 23 is fitted into the inner surface of the holding member 22, which is formed into a substantially concave spherical shape. The sliding member 23 has a substantially annular shape in plan view, and is formed in a substantially spherical band shape cut by two planes perpendicular to the central axis. The sliding member 23 covers the entire upper hemispherical surface of the inner surface of the holding member 22. The distance from the center of the spherical body 21 to the holding member 22 or the sliding member 23 is shorter in the upper hemisphere than in the lower hemisphere. Therefore, the sliding member 23 functions as a sliding section of the holding member 22 that comes into contact with the spherical body 21, and the spherical body 21 performs various movement such as tilting movement while being in contact with the sliding member 23 having a short distance. The sliding member 23 is formed by using resin having a low coefficient of friction. In this way, frictional resistance compared to the case where the spherical body 21 and the holding member 22 rotate while being in direct contact with each other may be reduced.

As described above, the operated device 2 disclosed in the present application has excellent effects such as that the sliding member 23 fitted into the upper side of the inner surface of the holding member 22 functions as a sliding section that comes into contact with the spherical body 21 in response to movement such as tilting movement of the spherical body 21, and reduces the frictional resistance between the sliding member 23 and the spherical body 21. In this way, the operator who operates the device for operating 1 may operate the device for operating 1 with little force.

### Third Embodiment

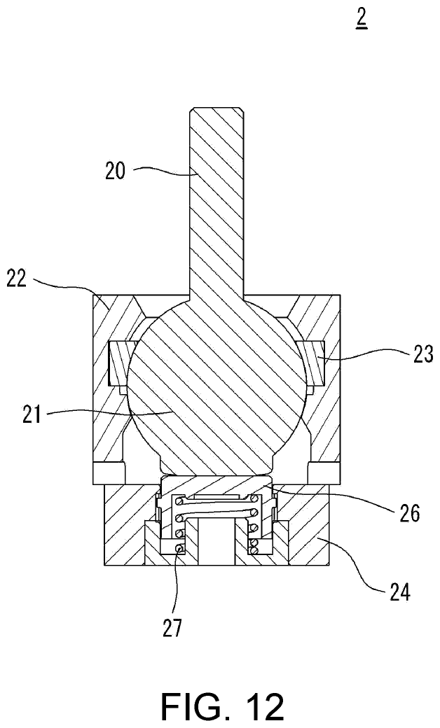

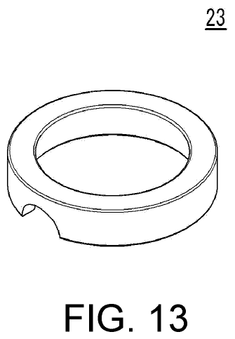

A third embodiment of the operated device 2 is a form in which the part of the sliding member 23 that contacts the spherical body 21 as a sliding section in the second embodiment is made smaller. In the following description, the same reference numerals as in the second embodiment, etc. are given to the same configurations as in the second embodiment, etc., and detailed description thereof will be omitted. FIG. 12 is a schematic cross-sectional view showing an example of the operated device 2 disclosed in the present application. FIG. 13 is a schematic perspective view showing an example of the sliding member 23 included in the operated device 2 disclosed in the present application. The schematic cross-sectional view illustrated in FIG. 12 is cut along a cross section where the opening section 212 of the holding member 22 is not formed, and the insides of the spherical body 21 and the shaft member 20 are omitted and shown with diagonal lines.

The sliding member 23 has a substantially annular shape in plan view, and is formed in a substantially spherical band shape cut by two planes perpendicular to the central axis. The height of the sliding member 23 of the operated device 2 according to the third embodiment is suppressed so as to cover merely the lower part of the upper hemispherical surface of the inner surface of the holding member 22 formed in a substantially concave spherical shape.

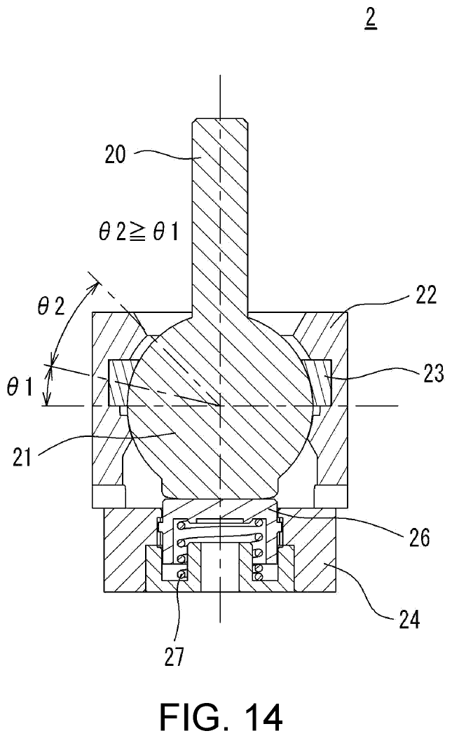

FIG. 14 is a schematic cross-sectional view showing an example of the operated device 2 disclosed in the present application. FIG. 14 shows the relationship between the disposition of the sliding member 23 and the inclination angle of the central axis of the spherical body 21 in the operated device 2. The disposition position of the sliding member 23 is defined as a first angle θ1, which is an elevation angle from a horizontal plane passing through the center of the spherical body 21. Here, the disposition position is an angle at a position midway between the horizontal plane, which is the lower end of the range in which the sliding member 23 contacts the spherical body 21, and the upper end. In addition, the maximum value of the tilt angle of the shaft member 20 at which the central axis of the spherical body 21 tilts is defined as a second angle θ1+θ2 from the horizontal plane passing through the center of the spherical body 21. When the first angle θ1 and the second angle θ1+θ2 are defined in this way, the first angle θ1 is disposed to be less than or equal to ½ of the second angle θ1+θ2. That is, θ2≥θ1.

A dynamic model in which the tilted spherical body 21 is pressed by the pressing member 26 and returns to the reference posture will be described. Assuming that the force that the spherical body 21 receives upward from the pressing member 26 is F, and the coefficient of friction between the spherical body 21 and the sliding member 23 is μ, the frictional force at the position of the first angle θ1, which is the elevation angle of the sliding member 23, may be expressed by the following Formula 1. Further, if the radius from the center of the spherical body 21 to the point where the spherical body 21 contacts the sliding member 23 is R, the rotational moment when the tilted spherical body 21 returns to the reference posture may be expressed by the following Formula 2.

Frictional force: μ·F·cos(90°−θ1) Formula 1

Rotational moment: R·μ·F·cos θ1 Formula 2

From Formula 1, the smaller the first angle θ1, the smaller the frictional force between the spherical body 21 and the sliding member 23. From Formula 2, the smaller the first angle θ1, the smaller the rotational moment. As is clear from Formula 1 and Formula 2, the lower the position where the sliding member 23 contacts the spherical body 21, the smaller the friction. Further, it is clear that the tilted spherical body 21 easily rotates for return. By disposing the operated device 2 according to the third embodiment so that the first angle is ½ or less of the second angle, the frictional resistance is reduced and the rotational moment is also reduced.

As described above, in the operated device 2 disclosed in the present application, the sliding member 23 fitted into the upper side of the inner surface of the holding member 22 functions as a sliding section that comes into contact with the spherical body 21, and reduces the frictional resistance between the sliding member 23 and the spherical body 21. In particular, the operated device 2 according to the third embodiment may reduce frictional resistance and rotate easily by disposing the sliding member 23 at a low position.

### Fourth Embodiment

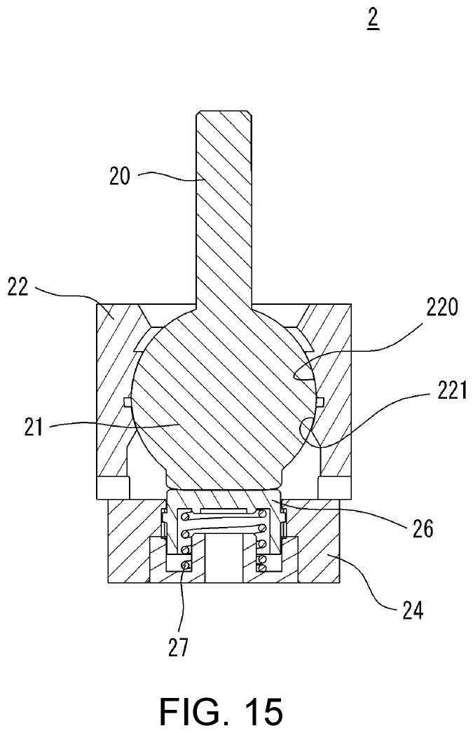

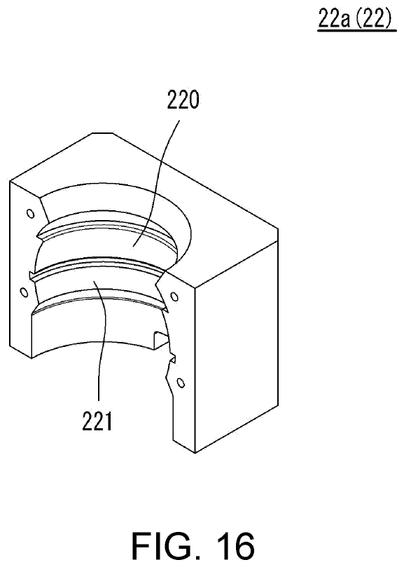

A fourth embodiment of the operated device 2 is a form in which the sliding member 23 in the third embodiment is not used, and a part of the holding member 22 is configured as a sliding section 220. In the following description, the same reference numerals as in the third embodiment, etc. are given to the same configurations as in the third embodiment, etc., and detailed description thereof will be omitted. FIG. 15 is a schematic cross-sectional view showing an example of the operated device 2 disclosed in the present application. FIG. 16 is a schematic perspective view showing an example of the holding member 22 included in the operated device 2 disclosed in the present application. The schematic cross-sectional view illustrated in FIG. 15 is cut along a cross section where the opening section 212 of the holding member 22 is not formed, and the insides of the spherical body 21 and the shaft member 20 are omitted and shown with diagonal lines. FIG. 16 shows the appearance of the half body 22a from which the holding member 22 is separated.

The inner surface of the holding member 22 is formed into a substantially concave spherical shape, and the sliding section 220 in an annular shape that protrudes inward (toward the spherical body 21 side) is formed on the upper hemispherical surface side. Furthermore, a support section 221 in an annular shape that protrudes inward is formed on the lower hemispherical surface side of the inner surface of the holding member 22. The sliding section 220 is disposed so that the elevation angle (first angle) of the disposition position is less than or equal to ½ of the elevation angle (second angle) of the maximum value of the tilt angle of the central axis of the spherical body 21. The sliding section 220 formed on the upper hemispherical surface side of the holding member 22 is a part that the spherical body 21 comes into contact with, and moves while being in contact with the spherical body 21. The support section 221 formed on the lower hemispherical surface of the holding member 22 is formed to hold the spherical body 21 stably. The distance from the center of the spherical body 21 to the sliding section 220 is formed to be shorter than the distance from the center to the support section 221.

As described above, in the operated device 2 disclosed in the present application, the sliding section 220 is formed in the holding member 22. Since the sliding section 220 of the holding member 22 is disposed at a low position, frictional resistance may be reduced.

### Fifth Embodiment

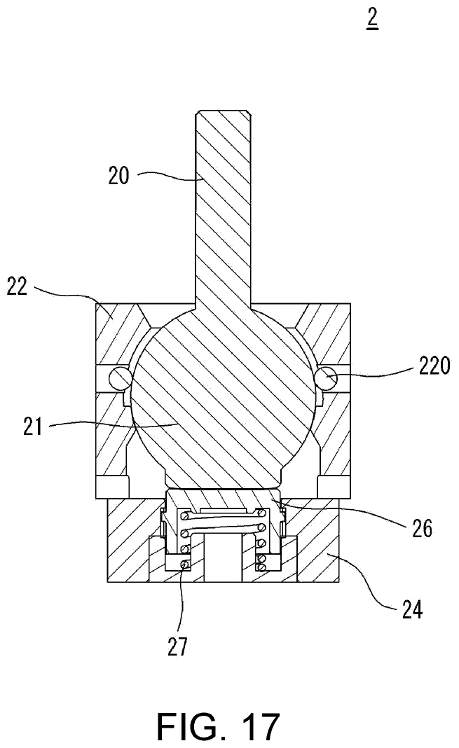

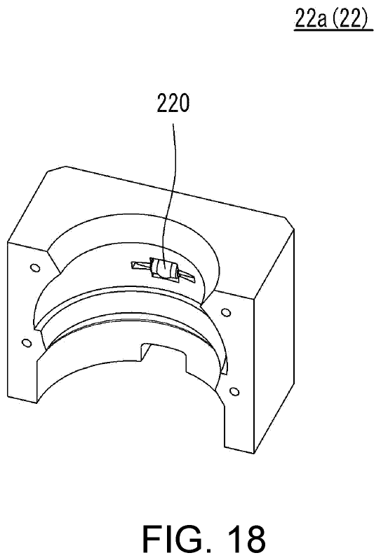

A fifth embodiment of the operated device 2 is a form in which a rolling bearing is used as the sliding section 220 in the fourth embodiment. In the following description, the same reference numerals as in the fourth embodiment, etc. are given to the same configurations as in the fourth embodiment, etc., and detailed description thereof will be omitted. FIG. 17 is a schematic cross-sectional view showing an example of the operated device 2 disclosed in the present application. FIG. 18 is a schematic perspective view showing an example of the holding member 22 included in the operated device 2 disclosed in the present application. The schematic cross-sectional view illustrated in FIG. 17 is cut along a cross section where the opening section 212 of the holding member 22 is not formed, and the insides of the spherical body 21 and the shaft member 20 are omitted and shown with diagonal lines. FIG. 18 shows the appearance of the half body 22a from which the holding member 22 is separated.

The inner surface of the holding member 22 is formed in a substantially concave spherical shape, and the sliding section 220 that comes into contact with the spherical body 21 is formed on the upper hemispherical surface. The sliding section 220 according to the fifth embodiment is formed as a rolling bearing using rollers. The rollers as the sliding section 220 are formed at three locations, for example, at intervals of 120°. Since the spherical body 21 slides in contact with the rollers of the sliding section 220, the frictional resistance between the spherical body 21 and the holding member 22 may be reduced.

As described above, in the operated device 2 disclosed in the present application, since the sliding section 220 using rollers is formed in the holding member 22, the frictional resistance between the holding member 22 and the spherical body 21 may be reduced. The sliding section 220 according to the fifth embodiment may also be formed as a rolling bearing using balls.

### Sixth Embodiment

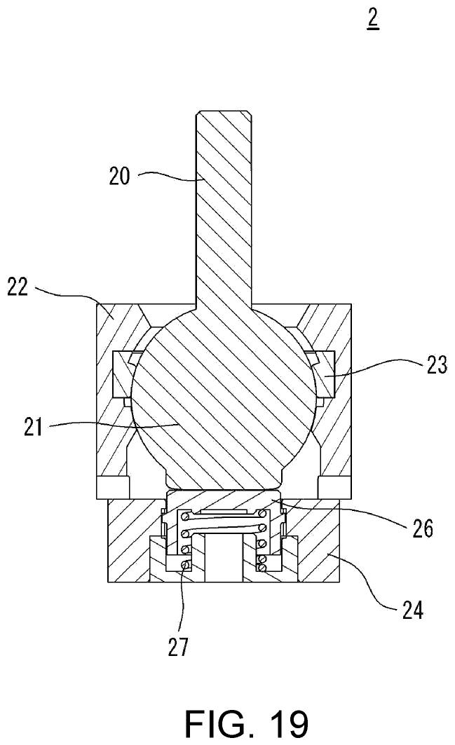

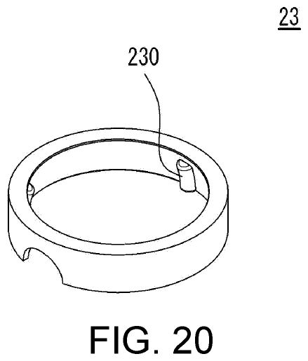

A sixth embodiment of the operated device 2 is a form in which instead of using the entire inner surface of the sliding member 23 as a sliding section in the third embodiment, a protrusion that functions as a sliding section 230 is formed on the sliding member 23. In the following description, the same reference numerals as in the third embodiment, etc. are given to the same configurations as in the third embodiment, etc., and detailed description thereof will be omitted. FIG. 19 is a schematic cross-sectional view showing an example of the operated device 2 disclosed in the present application. FIG. 20 is a schematic perspective view showing an example of the sliding member 23 included in the operated device 2 disclosed in the present application. The schematic cross-sectional view illustrated in FIG. 19 is cut along a cross section where the opening section 212 of the holding member 22 is not formed, and the insides of the spherical body 21 and the shaft member 20 are omitted and shown with diagonal lines.

The sliding member 23 has a substantially annular shape in plan view, and is formed in a substantially spherical band shape cut by two planes perpendicular to the central axis. Three sliding sections 230 are formed on the inner surface of the sliding member 23 at intervals of 120°. The sliding section 230 is formed as a substantially semi-cylindrical protrusion so that a generatrix direction is approximately in the up-and-down direction along the tangent of the sliding member 23. By using the sliding member 23 having the sliding section 230 formed as a protrusion, the operated device 2 according to the sixth embodiment has excellent effects such as being able to reduce the contact area between the sliding member 23 and the spherical body 21 and reduce frictional resistance.

### Seventh Embodiment

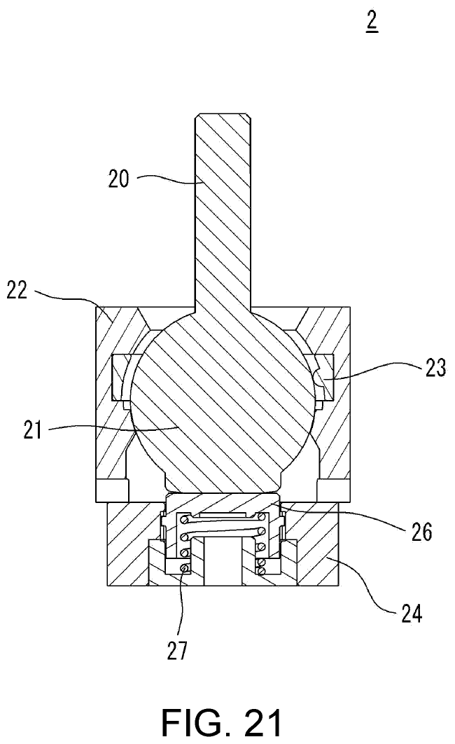

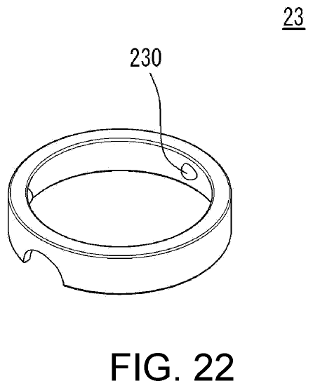

A seventh embodiment of the operated device 2 is a form in which the sliding section 230 in the sixth embodiment has a substantially hemispherical shape. In the following description, the same reference numerals as in the sixth embodiment, etc. are given to the same configurations as in the sixth embodiment, etc., and detailed description thereof will be omitted. FIG. 21 is a schematic cross-sectional view showing an example of the operated device 2 disclosed in the present application. FIG. 22 is a schematic perspective view showing an example of the sliding member 23 included in the operated device 2 disclosed in the present application. The schematic cross-sectional view illustrated in FIG. 21 is cut along a cross section where the opening section 212 of the holding member 22 is not formed, and the insides of the spherical body 21 and the shaft member 20 are omitted and shown with diagonal lines.

The sliding member 23 has a substantially annular shape in plan view, and is formed in a substantially spherical band shape cut by two planes perpendicular to the central axis. Three sliding sections 230 are formed on the inner surface of the sliding member 23 at intervals of 120°. The sliding section 230 is formed as a substantially hemispherical protrusion. By using the sliding member 23 having the sliding section 230 formed as a protrusion, the operated device 2 according to the sixth embodiment reduces the contact area between the sliding member 23 and the spherical body 21 and reduces frictional resistance.

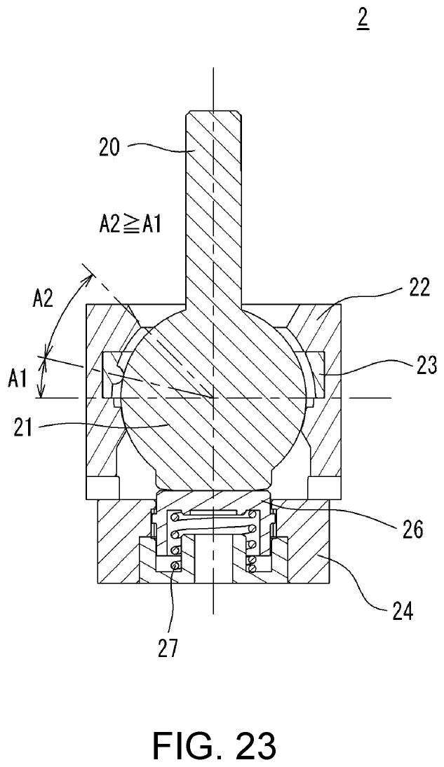

FIG. 23 is a schematic cross-sectional view showing an example of the operated device 2 disclosed in the present application. FIG. 23 shows the relationship between the disposition of the sliding section 230 of the sliding member 23 and the tilt angle of the central axis of the spherical body 21. The position of the sliding section 230 formed as a protrusion is defined as a first angle A1 as an elevation angle from a horizontal plane passing through the center of the spherical body 21. Further, the maximum value of the tilt angle of the shaft member 20, which is the tilt angle of the central axis of the spherical body 21, is defined as a second angle A1+A2, which is an elevation angle from a horizontal plane passing through the center of the spherical body 21. When the first angle A1 and the second angle A1+A2 are defined in this way, the first angle A1 is disposed to be less than or equal to ½ of the second angle A1+A2. That is, A2≥A1.

The dynamic model when the tilted spherical body 21 is pressed by the pressing member 26 and returns to the reference posture is the same as Formula 1 and Formula 2 of the third embodiment. That is, the smaller the first angle A1, the smaller the frictional force between the spherical body 21 and the sliding member 23, and the smaller the first angle A1, the smaller the rotational moment. Further, the lower the position where the sliding section 230 contacts the spherical body 21, the smaller the friction, and the more easily the tilted spherical body 21 rotates to return. By disposing the operated device 2 according to the seventh embodiment so that the first angle A1 is less than or equal to ½ of the second angle A1+A2, frictional resistance is reduced and rotational moment is also reduced.

As described above, in the operated device 2 disclosed in the present application, since the sliding section 230 is formed as a hemispherical protrusion on the sliding member 23, the contact area between the sliding member 23 and the spherical body 21 is reduced, and the frictional resistance is reduced. Moreover, by disposing the sliding section 230 at a low position, the operated device 2 disclosed in the present application has excellent effects such as being able to reduce frictional resistance and rotational moment.

### Eighth Embodiment

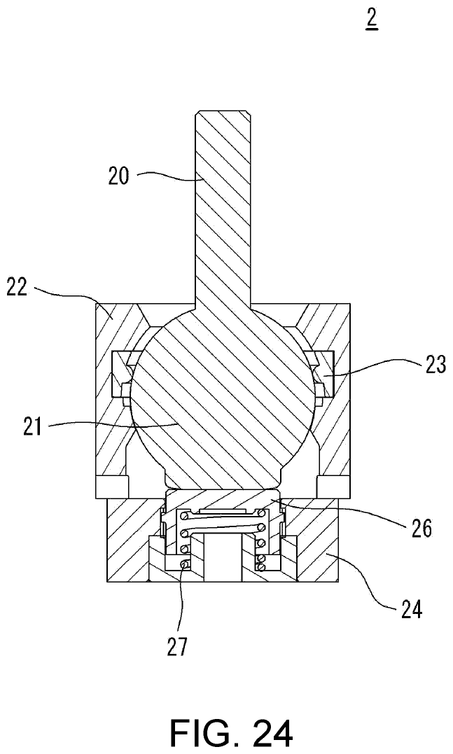

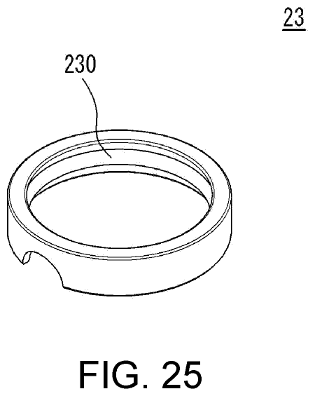

An eighth embodiment of the operated device 2 is a form in which the sliding section 230 in the seventh embodiment has a substantially annular shape. In the following description, the same reference numerals as in the seventh embodiment are given to the same configurations as in the seventh embodiment, and detailed description thereof will be omitted. FIG. 24 is a schematic cross-sectional view showing an example of the operated device 2 disclosed in the present application. FIG. 25 is a schematic perspective view showing an example of the sliding member 23 included in the operated device 2 disclosed in the present application. The schematic cross-sectional view illustrated in FIG. 24 is cut along a cross section where the opening section 212 of the holding member 22 is not formed, and the insides of the spherical body 21 and the shaft member 20 are omitted and shown with diagonal lines.

The sliding member 23 has a substantially annular shape in plan view, and is formed in a substantially spherical band shape cut by two planes perpendicular to the central axis. The sliding section 230 having a substantially semicircular cross section in the radial direction is formed on the inner surface of the sliding member 23 so as to protrude inward. The sliding section 230 formed on the inner surface of the sliding member 23 extends inside along the inner surface of the sliding member 23, and is formed to have a substantially annular shape in plan view. That is, the sliding section 230 is formed as a protrusion on the inner surface of the sliding member 23. By using the sliding member 23 having the sliding section 230 formed as a protrusion, the operated device 2 according to the eighth embodiment reduces the contact area between the sliding member 23 and the spherical body 21 and reduces frictional resistance.

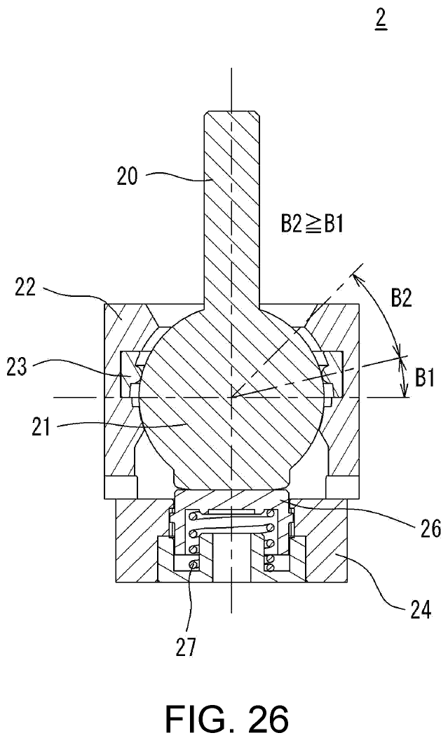

FIG. 26 is a schematic cross-sectional view showing an example of the operated device 2 disclosed in the present application. FIG. 26 shows the relationship between the disposition of the sliding section 230 of the sliding member 23 and the tilt angle of the central axis of the spherical body 21. The position of the sliding section 230 formed as a protrusion is defined as a first angle B1 as an elevation angle from a horizontal plane passing through the center of the spherical body 21. Further, the maximum value of the tilt angle of the shaft member 20, which is the tilt angle of the central axis of the spherical body 21, is defined as a second angle B1+B2, which is an elevation angle from a horizontal plane passing through the center of the spherical body 21. When the first angle B1 and the second angle B1+B2 are defined in this way, the first angle B1 is disposed to be less than or equal to ½ of the second angle B1+B2. That is, B22≥B1.

The dynamic model when the tilted spherical body 21 is pressed by the pressing member 26 and returns to the reference posture is the same as Formula 1 and Formula 2 of the third embodiment. That is, the smaller the first angle B1, the smaller the frictional force between the spherical body 21 and the sliding member 23, and the smaller the first angle B1, the smaller the rotational moment. Further, the lower the position where the sliding section 230 contacts the spherical body 21, the smaller the friction, and the more easily the tilted spherical body 21 rotates to return. By disposing the operated device 2 according to the eighth embodiment so that the first angle B1 is less than or equal to ½ of the second angle B1+B2, frictional resistance is reduced and rotational moment is also reduced.

As described above, in the operated device 2 disclosed in the present application, the sliding section 230 is formed on the sliding member 23 as a protrusion having a substantially semicircular cross section in the radial direction, the contact area between the sliding member 23 and the spherical body 21 is reduced, and the frictional resistance is reduced. Moreover, by disposing the sliding section 230 at a low position, the operated device 2 disclosed in the present application has excellent effects such as being able to reduce frictional resistance and rotational moment.

### Ninth Embodiment

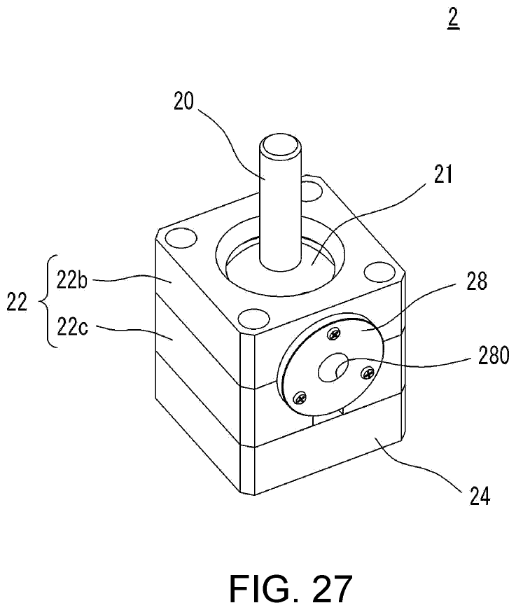

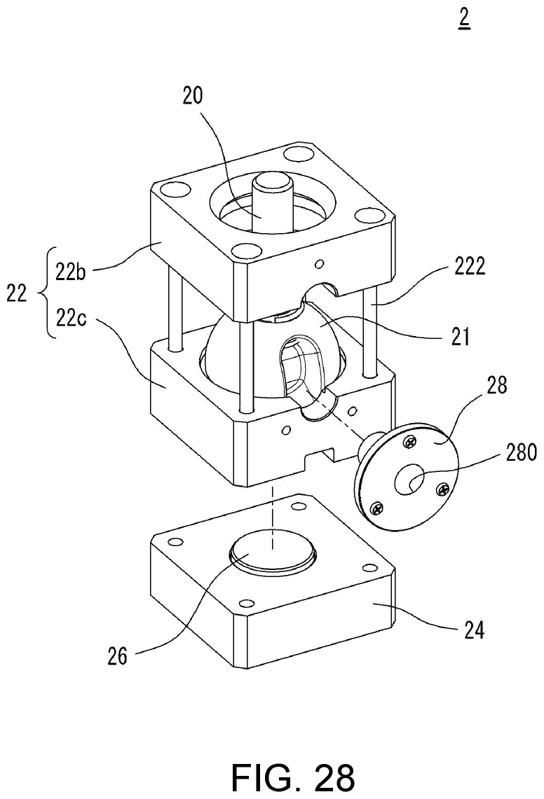

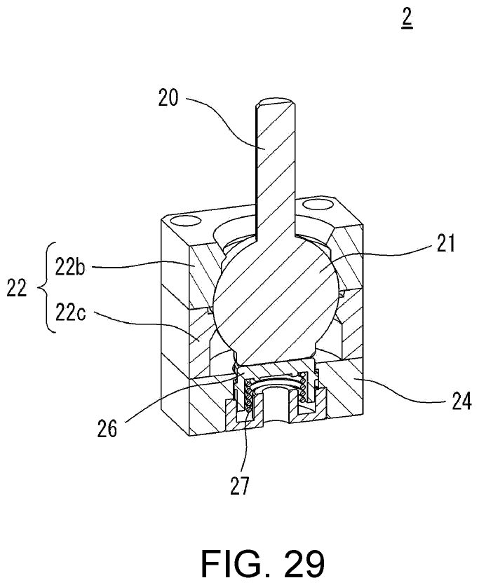

A ninth embodiment of the operated device 2 is a form in which the holding member 22 in the fourth embodiment is shaped so that the upper and lower parts may be separated. In the following description, the same reference numerals as in the fourth embodiment, etc. are given to the same configurations as in the fourth embodiment, etc., and detailed description thereof will be omitted. FIG. 27 is a schematic perspective view showing an example of the operated device 2 disclosed in the present application. FIG. 28 is a schematic exploded perspective view showing an example of the operated device 2 disclosed in the present application. FIG. 29 is a schematic cross-sectional perspective view showing an example of the operated device 2 disclosed in the present application. In the schematic cross-sectional perspective view illustrated in FIG. 29, the insides of the spherical body 21 and the shaft member 20 are omitted and shown with diagonal lines.

The holding member 22 of the operated device 2 according to the ninth embodiment has a substantially rectangular outer diameter. The holding member 22 is assembled by combining an upper half body 22b and a lower half body 22c which are separable up and down. The upper half body 22b of the holding member 22 covers the upper hemisphere of the spherical body 21 from above, and the lower half body 22c covers the lower hemisphere of the spherical body 21 from below. The radius of curvature of the concave spherical surface of the upper half body 22b is formed to be larger than the radius of curvature of the concave spherical surface of the lower half body 22c. Therefore, the distance from the center of the spherical body 21 to the concave spherical surface of the upper half body 22b is shorter than the distance from the center of the spherical body 21 to the concave spherical surface of the lower half body 22c. The upper half body 22b and the lower half body 22c are assembled as the holding member 22 in a state in which movement in directions other than the up-and-down direction is restricted by bar-shaped restriction shafts 222 disposed at the four corners of the opposing horizontal planes. A substantially circular through-hole is formed in one side surface of the holding member 22, and the through-hole is closed with a lid body 28. The lid body 28 is formed with a cylindrical section 280 in a substantially cylindrical shape that extends into the interior of the holding member 22. The tip of the cylindrical section 280 enters the spherical body 21 through the opening section 212 and is formed so that the connection line 250 of the detection unit 25 is inserted therethrough.

As described above, the operated device 2 disclosed in the present application may be developed into various forms, such as by configuring the holding member 22 to be separable up and down.

### Functional Configuration Example

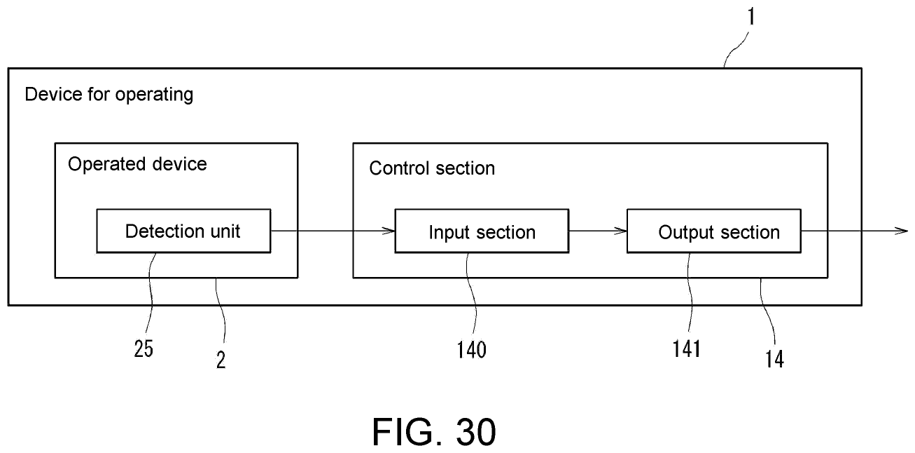

Next, a functional configuration example of the device for operating 1 disclosed in the present application will be described. FIG. 30 is a block diagram showing a functional configuration example of the device for operating 1 disclosed in the present application. The device for operating 1 includes a control section 14 configured to use electronic components such as various electronic elements, various electric circuits, and a microcomputer. The control section 14 includes an input section 140 and an output section 141. The input section 140 receives an electrical signal input based on the movement of the spherical body 21 from the connection line 250 of the detection unit 25 of the operated device 2. The control section 14 generates an operation signal by performing various calculations on the electrical signal input from the input section 140. The output section 141 transmits the generated operation signal to a device to be operated, such as a game machine, a personal computer, an industrial robot, or the like. By transmitting the operation signal to the operation target, the operator may operate the operation target by using the device for operating 1.

As described above, the device for operating 1 and the operated device 2 disclosed in the present application have excellent effects such as being able to reduce the frictional resistance that occurs when the spherical body 21 moves by the sliding section 230 that contacts the spherical body 21.

The present invention is not limited to the embodiments described above, and may be implemented in various other forms. Therefore, the embodiments described above are merely illustrative in every respect, and should not be interpreted in a limiting manner. The technical scope of the present invention is described by the claims and is not restricted by the text of the specification. Furthermore, all modifications and changes within the equivalent scope of claims are within the scope of the present invention.

For example, the embodiments exemplified as the first to ninth embodiments are not limited to being implemented independently, but may be combined as appropriate.

Also, for example, in the above-described embodiment, a form applied to a game controller has been described, but the embodiment is not limited thereto, and can be used to operate various objects to be operated, such as various toys, various mobile objects, various measuring devices, and industrial robots. Furthermore, the operated device 2 described in the present application may be applied not only to the device for operating 1 but also to various devices in which spherical joints such as joints of industrial robots may be incorporated.

Further, for example, in the embodiment, although a form in which the spherical body 21 does not move in conjunction with the rotational movement of the shaft member 20 is illustrated, the embodiment is not limited thereto, and may be developed into various forms such as a form in which the spherical body 21 moves conjunctively. Regarding the friction between the spherical body 21 and the holding member 22 that occurs when the spherical body 21 moves in conjunction with the rotational movement of the shaft member 20, the friction may be reduced by the configuration of the sliding section such as the sliding member 23 disclosed in the present application.

Further, for example, in the embodiment described above, a form in which the movement of the spherical body 21 is detected by using the magnetic field sensor 253, but the present invention is not limited thereto, and various forms for detecting the movement of the spherical body 21 may be developed.

Further, for example, in the above embodiment, as long as the sliding section 230 of the sliding member 23 or the sliding section 220 of the holding member 22 contacts the upper hemispherical surface of the spherical body 21, the contact position may be designed as appropriate. For example, various designs are possible, such as designing the spherical body 21 to come into contact with the sliding section 230 or the sliding section 220 in a range of the elevation angle of 0 to 30 degrees, 5 to 15 degrees, 30 to 45 degrees, etc. from a horizontal plane passing through the center of the spherical body 21.

### REFERENCE SIGNS LIST

1: device for operating
14: control section
140: input section
141: output section
2: operated device
20: shaft member
21: spherical body
213: pressed section
22: holding member
22a: half body
22b: upper half body
22c: lower half body
220: sliding section
23: sliding member (sliding section)
230: sliding section
25: detection unit
26: pressing member

1. An operated device, comprising:
a spherical body, moving upon receiving an operation from an external source; and
a holding member, movably holding the spherical body from an outside, wherein
the holding member has a sliding section that contacts an outer surface of the spherical body,
the operated device comprises a pressing member that presses the spherical body and brings the spherical body into contact with the sliding section, and
the spherical body moves while being in contact with the sliding section.

2. The operated device according to claim 1, wherein
the pressing member presses from a first hemispherical surface side of the spherical body, and
the sliding section is disposed to come into contact merely with a second hemispherical surface side opposite to the first hemispherical surface side.

3. The operated device according to claim 2, wherein
an inner surface of the holding member is formed in a concave spherical shape along the outer surface of the spherical body, and
the inner surface of the holding member has a radius of a second concave spherical surface side facing the second hemispherical surface side opposite to the first hemispherical surface side of the spherical body shorter than a radius of a first concave spherical surface side facing the first hemispherical surface side of the spherical body that receives pressure from the pressing member.

4. The operated device according to claim 1, wherein
the sliding section is formed of a spherical band-shaped member cut along two planes perpendicular to a pressing direction of the pressing member.

5. The operated device according to claim 4, wherein
the sliding section is formed by using a material having a smaller coefficient of friction than other parts of the holding member.

6. The operated device according to claim 4, wherein
the sliding section is formed by using polyacetal resin (POM), polyamide resin (PA) or polytetrafluoroethylene resin (PTFE).

7. The operated device according to claim 1, wherein
movement of the spherical body is tilting movement in which a central axis parallel to the pressing direction of the pressing member is tilted,
the sliding section is disposed such that an elevation angle from a center of the spherical body is a first angle with respect to a plane perpendicular to the pressing direction of the pressing member,
the central axis is tiltable to a second angle with respect to a plane perpendicular to the pressing direction of the pressing member by tilting movement, and
the first angle is ½ or less of the second angle.

8. The operated device according to claim 1, wherein
the sliding section is formed as a rolling bearing.

9. A device for operating, comprising:
the operated device according to claim 1; and
an output section, outputting an operation signal based on movement of the spherical body comprised in the operated device to the external source.

10. The operated device according to claim 2, wherein
the sliding section is formed of a spherical band-shaped member cut along two planes perpendicular to a pressing direction of the pressing member.

11. The operated device according to claim 3, wherein
the sliding section is formed of a spherical band-shaped member cut along two planes perpendicular to a pressing direction of the pressing member.

12. The operated device according to claim 10, wherein
the sliding section is formed by using a material having a smaller coefficient of friction than other parts of the holding member.

13. The operated device according to claim 11, wherein
the sliding section is formed by using a material having a smaller coefficient of friction than other parts of the holding member.

14. The operated device according to claim 10, wherein
the sliding section is formed by using polyacetal resin (POM), polyamide resin (PA) or polytetrafluoroethylene resin (PTFE).

15. The operated device according to claim 11, wherein
the sliding section is formed by using polyacetal resin (POM), polyamide resin (PA) or polytetrafluoroethylene resin (PTFE).

16. The operated device according to claim 5, wherein
the sliding section is formed by using polyacetal resin (POM), polyamide resin (PA) or polytetrafluoroethylene resin (PTFE).

17. The operated device according to claim 12, wherein
the sliding section is formed by using polyacetal resin (POM), polyamide resin (PA) or polytetrafluoroethylene resin (PTFE).

18. The operated device according to claim 13, wherein
the sliding section is formed by using polyacetal resin (POM), polyamide resin (PA) or polytetrafluoroethylene resin (PTFE).

19. The operated device according to claim 2, wherein
movement of the spherical body is tilting movement in which a central axis parallel to the pressing direction of the pressing member is tilted,
the sliding section is disposed such that an elevation angle from a center of the spherical body is a first angle with respect to a plane perpendicular to the pressing direction of the pressing member,
the central axis is tiltable to a second angle with respect to a plane perpendicular to the pressing direction of the pressing member by tilting movement, and
the first angle is ½ or less of the second angle.

20. The operated device according to claim 3, wherein
movement of the spherical body is tilting movement in which a central axis parallel to the pressing direction of the pressing member is tilted,
the sliding section is disposed such that an elevation angle from a center of the spherical body is a first angle with respect to a plane perpendicular to the pressing direction of the pressing member,
the central axis is tiltable to a second angle with respect to a plane perpendicular to the pressing direction of the pressing member by tilting movement, and
the first angle is ½ or less of the second angle.
